(19) United States
(12) Patent Application Publication
(10) Pub. No.: US 2015/0097090 A1
(43) Pub. Date: Apr. 9, 2015

(54) PORTABLE HOLDER FOR AN ELECTRIC VEHICLE CHARGER WITH AN INLINE ELECTRONICS MODULE

(71) Applicant: DELPHI TECHNOLOGIES, INC., Troy, MI (US)

(72) Inventor: STEVEN A. MUSICK, BURTON, OH (US)

(21) Appl. No.: 14/045,116

(22) Filed: Oct. 3, 2013

(51) Int. Cl. B60L 11/18; F16M 13/02; H01R 13/60

(52) U.S. Cl. CPC B60L 11/1809; H01R 13/60; F16M 13/022
USPC 248/74.3; 248/49; 248/65

(57) ABSTRACT

A portable holder for an electric vehicle charger with an inline electronics module. The holder includes or defines a cavity, a first extension, a second extension, and a slot. The cavity is configured to receive the inline electronics module through an opening in the cavity. The first extension is arranged about a first side of the cavity. The second extension is arranged about a second side of the cavity opposite the first side. The first extension and the second extension cooperate to hold in place a vehicle cord connected to the inline electronics module when the vehicle cord is wrapped around the cavity. The slot is defined by the second extension and the cavity. The slot is configured to receive a power cord connected to the inline electronics module when the inline electronics module is inserted into the cavity.

### TECHNICAL FIELD OF INVENTION

This disclosure generally relates to a portable holder for an electric vehicle charger with an inline electronics module, and more particularly relates to a slot defined by the holder configured to receive a power cord when an inline electronics module connected to the power cord is inserted into the holder.

### BACKGROUND OF INVENTION

Electric vehicle chargers have been proposed that have a power cord with a power plug that is plugged into a building power outlet, commonly known as a 110VAC outlet, and a vehicle cord with a vehicle plug that is plugged into a vehicle for charging batteries in the vehicle. Such chargers may also include an inline electronics module that converts or regulates power from the 110VAC outlet to a voltage suitable for charging the batteries. These chargers may be installed on a wall in a garage where the vehicle is stored when not in use, or may be stowed on the vehicle so the vehicle can be charged while away from home. Each of the vehicle cord and/or the power cord may be several meters long. If the vehicle cord and/or the power cord are left lying on the floor of the garage, or carelessly stowed in the vehicle, the charger may become damaged

### SUMMARY OF THE INVENTION

In accordance with one embodiment, a portable holder for an electric vehicle charger with an inline electronics module is provided. The holder includes or defines a cavity, a first extension, a second extension, and a slot. The cavity is configured to receive the inline electronics module through an opening in the cavity. The first extension is arranged about a first side of the cavity. The second extension is arranged about a second side of the cavity opposite the first side. The first extension and the second extension cooperate to hold in place a vehicle cord connected to the inline electronics module when the vehicle cord is wrapped around the cavity. The slot is defined by the second extension and the cavity. The slot is configured to receive a power cord connected to the inline electronics module when the inline electronics module is inserted into the cavity.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a perspective view of a holder in accordance in accordance with one embodiment;

FIG. 2 is a perspective view of the holder of FIG. 1 with an inline electronics module prior to the module being inserted into the holder in accordance with one embodiment;

FIG. 3 is a perspective view of the holder of FIG. 1 after the module is inserted into the holder in accordance with one embodiment; and

FIG. 4 is a cut-away sectional view of the holder of FIG. 1 in accordance with one embodiment.

### DETAILED DESCRIPTION

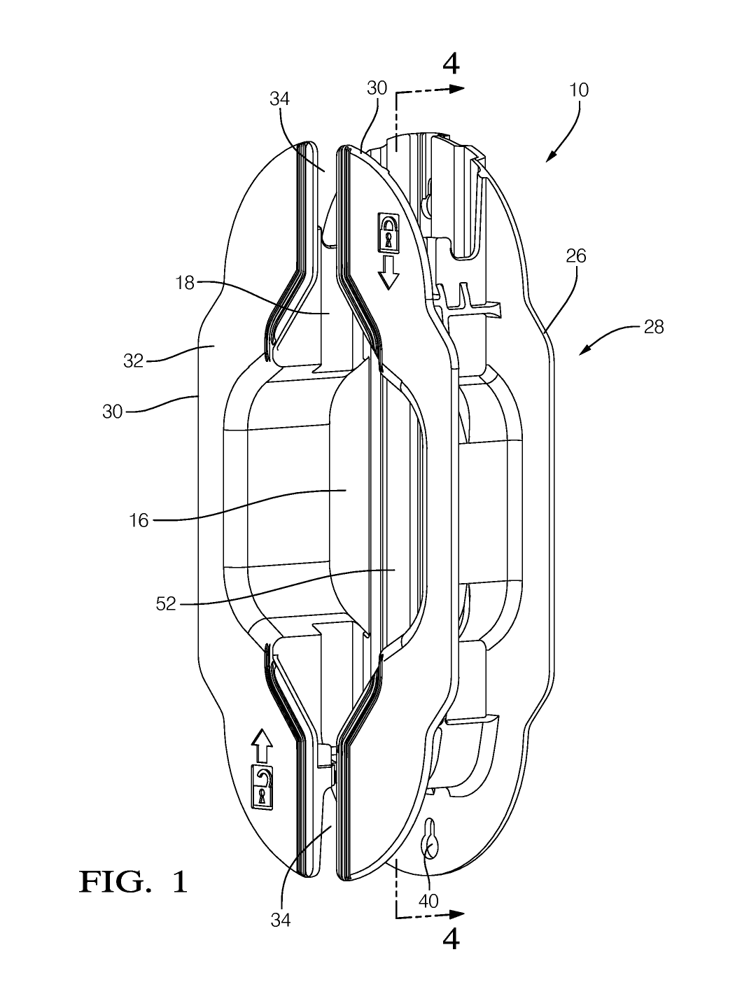

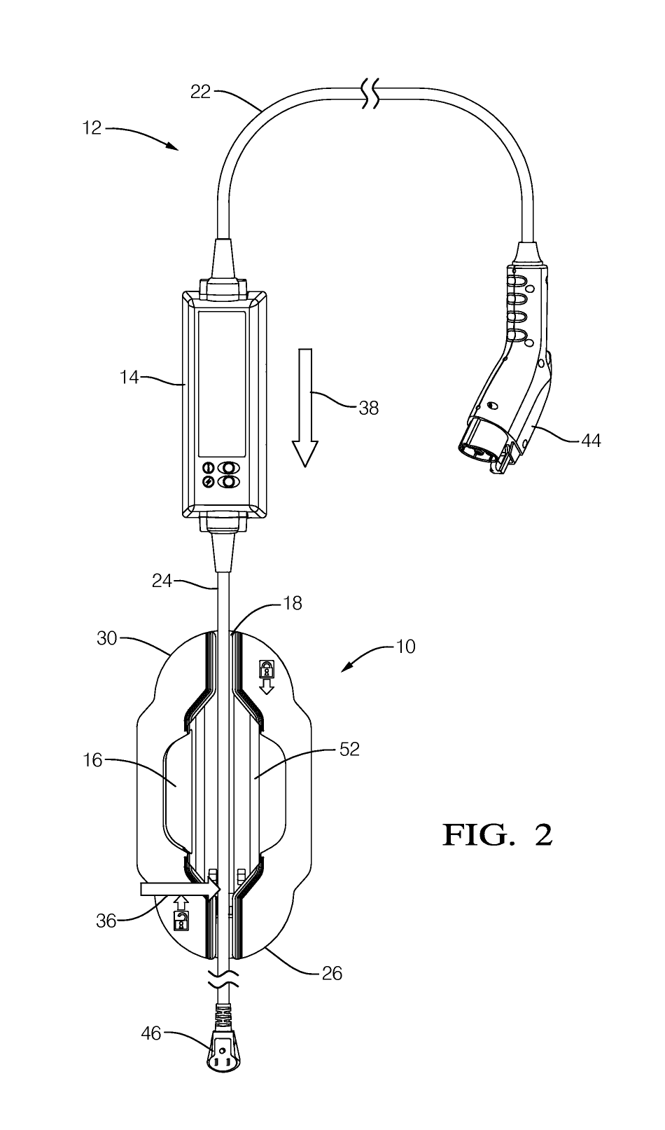

FIG. 1 illustrates a non-limiting example of a portable holder 10 for an electric vehicle charger 12 (FIG. 2) with an inline electronics module 14, hereafter referred to as the holder 10, the charger 12, and the module 14, respectively. As will be described in more detail below, the holder 10 is configured so the charger 12 can be readily placed into and removed from the holder 10 and the various cords can be readily and neatly organized upon the holder while it is mounted to the wall. Furthermore, the holder 10 is configured to be readily removed from a wall (not shown) or other structure on which the holder 10 is mounted so the various cords connected the module 14 can be readily and neatly organized upon the holder 10 for stowing, for example, in the trunk of vehicle (not shown).

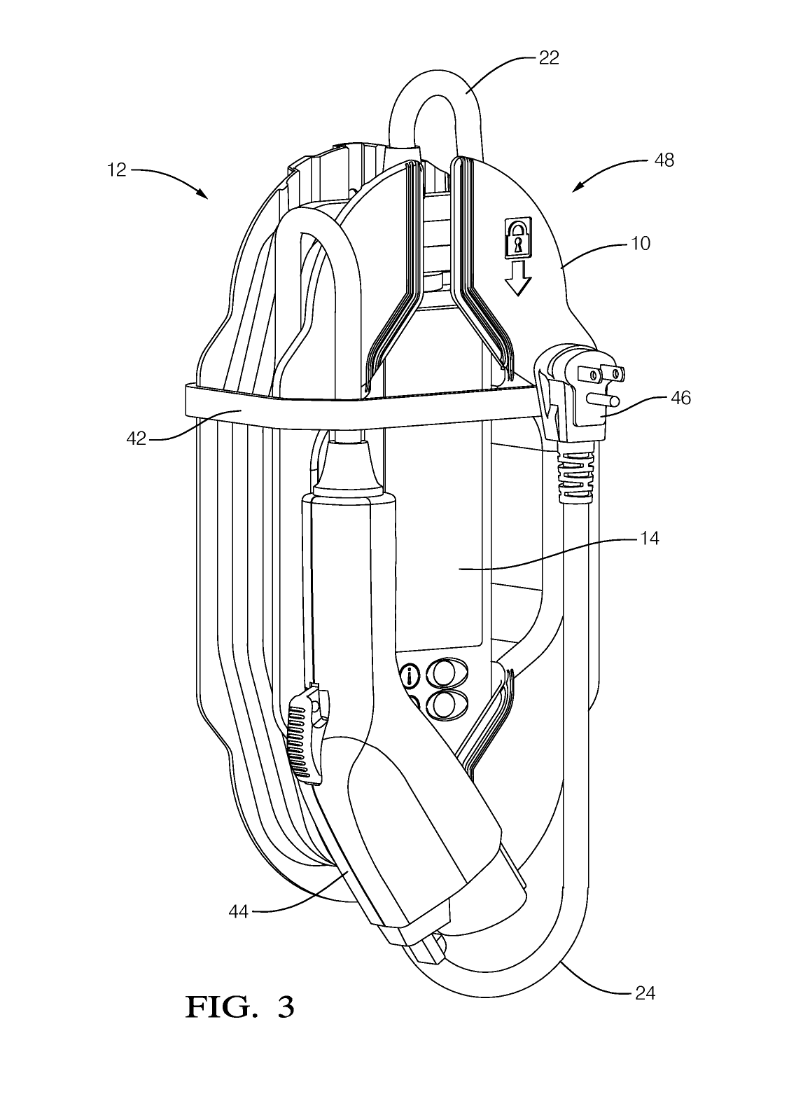

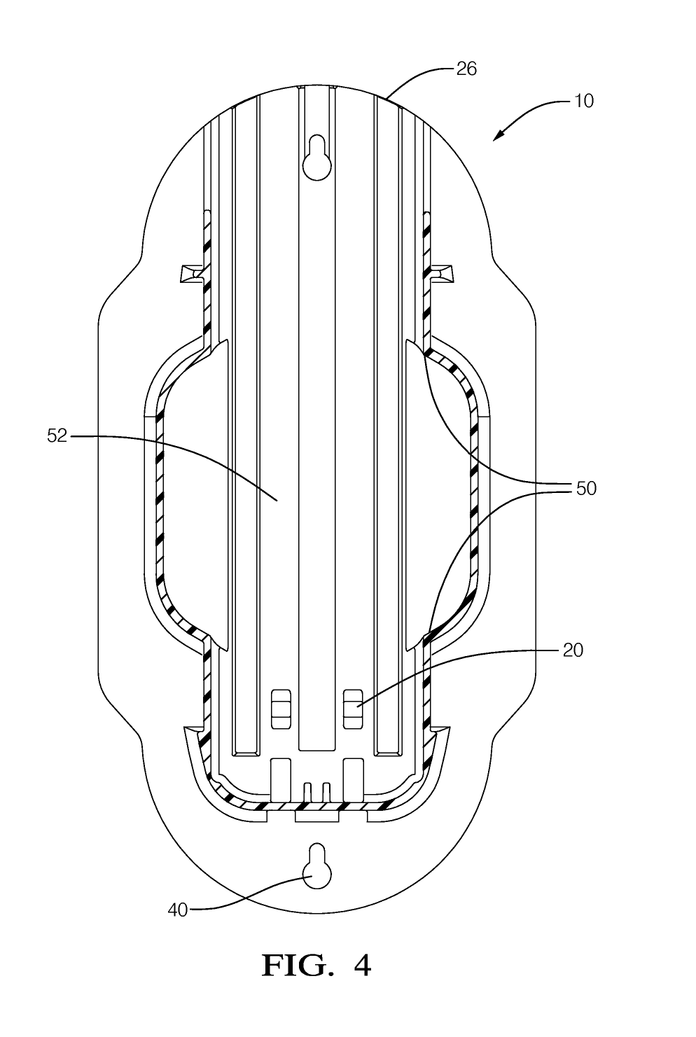

Continuing to refer to FIGS. 1 and 2, the holder 10 is configured to define a cavity 16 that is configured to receive the module 14 through an opening 18 in the cavity 16. The area defined as the cavity 16 may include a tab 20 (FIG. 4) or other such feature recognized by those in the art that is configured to engage with a mating feature (not shown) on the module 14 so the module 14 is removably retained in the cavity 16 after the module 14 is fully inserted into the cavity 16 as shown in FIG. 3. As used herein, removably retained means that the module 14 is held in place sufficient so that, for example, the holder 10 can be inverted from the orientation shown in FIGS. 1-3 and the module 14 will not fall out of the holder 10 due to gravity alone. However, if sufficient force is applied by a person, pushing with a thumb for example, the module 14 may be removed from the holder 10 without tools.

FIG. 4 further illustrates non-limiting details of the holder 10, in particular a cutout 50 is provided to form a flexible portion 52 of the holder 10 so that the tab 20 can deflect when the module 14 is inserted into the cavity 16.

The holder 10 advantageously includes features to help to organize and/or retain a vehicle cord 22 or power cord 24 of the charger 12 so that the cords are not tripped on, tangled, or otherwise inadvertently damaged. To this end, the holder 10 may include a first extension 26 arranged about a first side 28 (e.g. the back-side) of the cavity 16 or holder 10, and a second extension 30 arranged about a second side 32 (e.g. the front-side) of the cavity 16 or holder 10 that is opposite the first side 28. As can be seen in FIG. 3, the first extension 26 and the second extension 30 cooperate to hold the vehicle cord 22 when the vehicle cord 22 is wrapped around the cavity 16 or holder 10.

In order to simplify putting or removing the charger 12 from the holder 10, the holder advantageously includes a slot 34 that may be generally defined by the second extension 30 and/or the portion of the holder 10 defined as the cavity 16. The slot 34 is preferably configured to receive the power cord 24 when or just prior to the module 14 of the charger 12 being inserted into the cavity 16. By way of further explanation, the power cord 24 may be placed into the slot in the direction shown by the first arrow 36, and then the module 14 is placed into the cavity in the direction shown by the second arrow 38. This configuration of the slot 34 and the cavity 16 provide a holder 10 that the charger 12 can be placed into and removed quickly and easily while the holder is mounted to the wall as well as not mounted to the wall.

In order for the holder 10 to be useful as both a wall mounted device for holding the charger 12 and as a carrier for transporting the charger 12 in a neat and orderly manner, the holder 10 is preferably configured to be removably attached to a wall (not shown). In one embodiment, the first extension may include or define a key-hole 40 so the holder 10 can be removably attached to the wall. Alternatively, the holder 10 may be coupled or attached to the wall by way of a bracket (not shown) with features that cooperate with the holder 10 so the holder 10 can be readily removed from the wall.

FIG. 3 illustrates a non-limiting example where the assembly 48 of the holder 10 and the charger 12 includes a strap 42 configured to retain in place either or both the vehicle cord 22 with a corresponding vehicle plug 44 and/or the power cord 24 with a corresponding power plug 46 when the when either or both of the receptive cords are wrapped around the region of the holder 10 defined as the cavity 16. While the strap 42 may not be necessary to retain the cords & connectors when the holder 10 is attached to a wall, it may be useful to keep the vehicle plug 44 from being knocked off the holder 10 or from being brushed against or tangled if mounted to a wall in a high pedestrian traffic area. The strap 42 will be particularly useful to facilitate neat packaging/handling when the assembly 48 of the holder 10 and the charger 12 is removed from the wall. In one embodiment, the strap 42 is attached to the holder 10. Alternatively, the strap 42 may be attached to either the vehicle cord 22 or the power cord 24 so that the strap 42 can be used with and without the holder 10.

Accordingly, a portable holder (the holder 10) for an electric vehicle charger (the charger 12) with an inline electronics module (the module 14) is provided. The holder 10 is configured so the charger 12 can be quickly and easily placed into the holder 10, and the holder 10 is configured to be readily mounted to a wall or serve as a carrier for the charger 12 when, for example traveling in a vehicle. A strap 42 may be included to further secure the charger 12 to the holder 10.

While this invention has been described in terms of the preferred embodiments thereof, it is not intended to be so limited, but rather only to the extent set forth in the claims that follow.

We claim:

1. A portable holder for an electric vehicle charger with an inline electronics module, said holder comprising:
a cavity configured to receive the inline electronics module through an opening in the cavity;
a first extension arranged about a first side of the cavity;
a second extension arranged about a second side of the cavity opposite the first side, wherein the first extension and the second extension cooperate to hold in place a vehicle cord connected to the inline electronics module when the vehicle cord is wrapped around the cavity; and
a slot defined by the second extension and the cavity, said slot configured to receive a power cord connected to the inline electronics module when the inline electronics module is inserted into the cavity.

2. The holder in accordance with claim 1, wherein the holder is further configured to be removably attached to a wall.

3. The holder in accordance with claim 2, wherein first extension defines a key-hole so the holder can be removably attached to the wall.

4. The holder in accordance with claim 1, wherein the holder further comprises a strap configured to retain in place the vehicle cord when the vehicle cord is wrapped around the cavity.
